(19) United States
(12) Patent Application Publication
(10) Pub. No.: US 2011/0274943 A1
(43) Pub. Date: Nov. 10, 2011

(54) METAL MATERIAL PROCESSING METHOD, STRUCTURE PROCESSED USING METAL MATERIAL PROCESSING METHOD AND ROTARY TOOL

(75) Inventors: Hidetoshi Fujii, Osaka (JP); Tomoaki Miyazawa, Tokyo (JP); Tomohiro Maruko, Tokyo (JP); Takeshi Ishikawa, Kanagawa (JP); Kazuo Genchi, Kanagawa (JP)

(73) Assignees: OSAKA UNIVERSITY, Suita-shi, Osaka (JP); TOKYU CAR CORPORATION, Yokohama-shi, Kanagawa (JP); FURUYA METAL CO., LTD., Toshima-ku, Tokyo (JP)

(21) Appl. No.: 13/142,037

(22) PCT Filed: Dec. 24, 2009
(86) PCT No.: PCT/JP2009/071476

§ 371 Date: Jul. 28, 2011

(30) Foreign Application Priority Data
Dec. 24, 2008 (JP) 2008-327592

(51) Int. Cl. B32B 15/01; B23K 20/12

(52) U.S. Cl. 428/615; 228/112.1; 228/2.1

(57) ABSTRACT

In a metal material processing method, two metal materials are arranged to face each other in a processing portion, and a distal end of a rod-shaped rotary tool is inserted into the processing portion while rotating the rotary tool, thereby the two metal materials are processed. The distal end of the rotary tool has a probe protruding in a central portion and a shoulder in a peripheral portion. The probe and the shoulder are constituted by different materials in at least surface portions that are in contact with the metal materials.

### TECHNICAL FIELD

The present invention relates to a metal material processing method, a structure processed using the metal material processing method and a rotary tool, and more particularly to a processing method for processing metal materials by friction stir welding, a rotary tool, and a structure processed by the processing method.

### BACKGROUND ART

Among the convention metal material welding methods, a technique of welding metal materials by friction stir welding (FSW) is known. In friction stir welding, the metal materials that are to be welded are arranged opposite each other in the welding portion, a probe provided at the distal end of a rod-like rotary tool is inserted into the welding portion, while rotating the rotary tool, the rotating rotary tool is moved along the longitudinal direction of the welding portion, and the two metal materials are welded by friction heat that causes plastic flow of the metal materials. For example, Patent Document 1 discloses a technique of performing friction stir welding with a rotary tool in which a replaceable probe is provided in the central portion at the distal end of the rotary tool and a peripheral portion of the probe has a concave surface.

Further, Patent Document 2 discloses a tool for friction stir welding in which a probe pin protruding from the distal end surface of a rotating rotor is inserted into a welding portion of members to be welded and the members to be welded are friction stir welded in the welding portion. In such a rotary tool, the rotor and the probe pin are formed integrally from a superhard alloy, a locking portion is formed by cutting out at the rear side of the rotor, an accommodation portion for inserting therein the rear side of the rotor provided with the locking portion is provided in a shank portion constituted by a tool steel or a die steel, the rear side of the rotor is inserted into the accommodation portion, a screw is pushed against the locking portion of the rotor inserted into the accommodation portion, and the configuration in which the rotor and the probe pin are integrally formed is fixed to the shank portion. With the tool for friction stir welding that is described in Patent Document 2, the portion made from the superhard alloy can be decreased in size and cost can be reduced. Further, with the tool for friction stir welding that is described in Patent Document 2, even when the rotor or probe pin is worn out, the configuration in which the rotor and the probe pin are integrally formed can be easily replaced. Further, with the tool for friction stir welding that is described in Patent Document 2, a plurality of probe pins with different diameters and lengths can be prepared and used interchangeably as appropriate.

### Patent Literature

Patent Document 1: Japanese Translation of International Patent Application No. 9-508073.
Patent Document 2: Japanese Patent Application Publication No. 2005-199281.

### SUMMARY OF THE INVENTION

### Problem to be Solved by the Invention

Attempts have been made to perform friction stir welding of better quality by improving the structure, dimensions, shape, and materials of the rotary tool in the above-described technique. However, the perfect materials of the rotary tool vary significantly depending on the composition of metals that are to be welded by friction stir welding. The resultant problem is that it is difficult to extend sufficiently the service life of the rotary tool or obtain a better welding portion when performing friction stir welding of various metal materials by merely improving the structure, dimensions, shape, and material of the rotary tool.

The present invention has been created with the foregoing in view and it is an object thereof to provide a metal material processing method that makes it possible to extend sufficiently the service life of the rotary tool or obtain a better processing portion when performing friction stir welding of various metal materials.

### Means for Solving the Invention

The present invention provides a metal material processing method in which by arranging two metal materials to face each other in a processing portion and inserting a distal end of a rod-shaped rotary tool into the processing portion while rotating the rotary tool, the two metal materials are processed, wherein the distal end of the rotary tool has a probe protruding in a central portion and a shoulder in a peripheral portion, and the probe and the shoulder are constituted by different materials in at least surface portions that are in contact with the metal materials.

With such a configuration, since the probe and shoulder of the rotary tool are constituted by different materials at least in the surface portions that are in contact with the metal material, the possibility of adapting the rotary tool to friction stir welding of various metal materials is increased and the possibility of improving the service life of the rotary tool and quality of the processing portion is also increased.

The metal material processing methods in accordance with the present invention includes following four modes (1) to (4) and combinations thereof: (1) friction stir welding in which end portions of plate-like metal materials are abutted on each other to obtain a welding portion and the metal materials are welded to each other by moving, while rotating, the rotary tool along the longitudinal direction of the welding portion; (2) spot friction stir welding (spot FSW) in which end portions of plate-like metal materials are abutted on each other to obtain a welding portion and welding is performed by rotating the rotary tool, without moving, in the welding portion; (3) spot friction stir welding in which metal materials are laid one on top of another in a welding portion, a rotary tool is inserted into the welding portion, and the metal materials are welded together by rotating, without moving, the rotary tool in the insertion location; and (4) friction stir welding in which metal materials are laid one on top of another in a welding portion, a rotary tool is inserted into the welding portion, and the metal materials are welded together by moving, while rotating, the rotary tool along the longitudinal direction of the welding portion.

Further, with the metal material processing method in accordance with the present invention, the two metal materials are not simply welded in the processing portion, but the processing for modifying the processing portion by inserting the distal end of the rod-shaped rotary tool into the processing portion and rotating the rotary tool is also included.

In this case, it is preferred that wear resistance of the probe be higher than wear resistance of the shoulder.

With such a configuration, since wear resistance of the probe is higher than wear resistance of the shoulder, wear of the probe that is more prone to wear than the shoulder can be prevented and the rotary tool can be prevented from wear.

Further, it is preferred that adherability of the probe to the metal materials be higher than adherability of the shoulder to the metal materials.

With such a configuration, since adherability of the probe to the metal material is higher than adherability of the shoulder to the metal material, stirring of the metal materials is enhanced and volume of the stirring portion is increased. Since adherability of the shoulder to the metal material is lower than adherability of the probe to the metal material, roughening of the processing portion by the shoulder that passes over a wide region of the processing portion can be prevented.

Further, it is preferred that the probe be constituted by at least one of Ir, Mo, W, V, Rh, Ru, Re, Nb, Ta, Zr, and Hf, or an alloy including 50 wt. % or more of at least one of Ir, Mo, W, V, Rh, Ru, Re, Nb, Ta, Zr, and Hf.

With such a configuration, since the probe is constituted by at least one of Ir, Mo, W, V, Rh, Ru, Re, Nb, Ta, Zr, and Hf, or an alloy including 50 wt. % or more of at least one of Ir, Mo, W, V, Rh, Ru, Re, Nb, Ta, Zr, and Hf, wear resistance of the probe and adherability thereof to the metal materials can be sufficiently increased.

Alternatively, it is preferred that the probe include at least one of Cr, Si, Mo, V, Al, Nb, Ti, and W.

With such a configuration, since the probe includes at least one of Cr, Si, Mo, V, Al, Nb, Ti, and W, the occurrence of σ phase that causes the decrease in corrosion resistance in the processing portion can be inhibited.

It is preferred that the shoulder be constituted by either Si₃N₄ or polycrystalline cubic boron nitride.

With such a configuration, since the shoulder is constituted by at least either of Si₃N₄ and polycrystalline cubic boron nitride, adherability of the probe to the metal materials is higher than adherability of the shoulder to the metal materials, stirring of the metal materials is enhanced and volume of the stirring portion can be increased. Further, since adherability of the shoulder to the metal materials is lower than adherability of the probe to the metal materials, roughening of the processing portion by the shoulder that passes over a wide region of the processing portion can be prevented.

Further, it is preferred that the probe and the shoulder could be rotated at different rotation speeds, and the rotation speed of the probe be higher than the rotation speed of the shoulder.

With such a configuration, since the probe and the shoulder can be rotated at different rotation speeds, and the rotation speed of the probe is higher than the rotation speed of the shoulder, the temperature of the processing portion center where a high temperature is desirable can be raised by rotating the probe at a high speed, and the temperature of the entire processing portion, which is preferred, as a whole, to be maintained at a low temperature, can be reduced by rotating the shoulder at a low speed.

Further, it is preferred that a length of protrusion of the probe from the distal end of the rotary tool could be changed.

With such a configuration, since a length of protrusion of the probe from the distal end of the rotary tool can be changed, even when probe is worn out during processing, the rotary tool can be used continuously by changing the protrusion length of the probe from the distal end of the rotary tool.

Further, the surface portion of the shoulder can be covered with a substance having adherability to the metal material lower than adherability of the probe.

With such a configuration, even if the material of the entire shoulder is not changed from that of the probe, by covering the surface portion of the shoulder with a substance with adherability to the metal material lower than adherability of the probe, it is possible to obtain the effect that is identical to that obtained when the material of the entire shoulder is not changed from that of the probe.

In this case, the surface portion of the shoulder can be covered with one of Si₃N₄, BN, Al₂O₃, ZrO₂, SiC, B₄C, NiO, SiAlON, AlN, TiAlN, TiN, CrN, TiCN, TiSiN, DLC, TiCrN, TiAlSiN, and AlCrSiN.

With such a configuration, even when the material of the entire shoulder is not Si₃N₄ or polycrystalline cubic boron nitride, by covering the surface portion of the shoulder with one of Si₃N₄, BN, Al₂O₃, ZrO₂, SiC, B₄C, NiO, SiAlON, AlN, TiAlN, TiN, CrN, TiCN, TiSiN, DLC, TiCrN, TiAlSiN, and AlCrSiN, it is possible to obtain the effect that is identical to that obtained when the material of the entire shoulder is Si₃N₄ or polycrystalline cubic boron nitride.

Further, the surface portion of the probe can be covered with a substance having adherability to the metal material higher than adherability of the shoulder.

With such a configuration, even if the material of the entire probe is not changed from that of the shoulder, by covering the surface portion of the probe with a substance with adherability to the metal material higher than adherability of the shoulder, it is possible to obtain the effect that is identical to that obtained when the material of the entire probe is changed from that of the shoulder.

Further, the surface portion of the probe can be covered with a substance with wear resistance with respect to the metal material higher than wear resistance of the shoulder.

With such a configuration, even if the material of the entire probe is not changed from that of the shoulder, by covering the surface portion of the probe with a substance with wear resistance with respect to the metal material higher than wear resistance of the shoulder, it is possible to obtain the effect that is identical to that obtained when the material of the entire probe is changed from that of the shoulder.

In addition, the metal material is preferably constituted by at least one of stainless steels, carbon steels, alloy steels, Ni-base alloys, Ti, Co, Rh, Pd, Cu, Pt, and Au, or alloys including at least one of stainless steels, carbon steels, alloyed steels, Ni-base alloys, Ti, Co, Rh, Pd, Cu, Pt, and Au.

With the metal material processing method in accordance with the present invention, even when the metal materials include materials in which the rotary tool is easily worn out and the processing portion is easily roughened, such as at least one of stainless steels, carbon steels, alloy steels, Ni-base alloys, Ti, Co, Rh, Pd, Cu, Pt, and Au, or alloys including at least one of stainless steels, carbon steels, alloyed steels, Ni-base alloys, Ti, Co, Rh, Pd, Cu, Pt, and Au, wear of the rotary tool can the inhibited, and the processing portion can be prevented from roughening.

Furthermore, the structure processed by the metal material processing method in accordance with the present invention has a good processing portion and excels in mechanical properties.

The present invention also provides a rotary tool for use in a metal material processing method in which by arranging two metal materials to face each other in a processing portion and inserting a distal end of a rod-shaped rotary tool into the processing portion while rotating the rotary tool, the two metal materials are processed, wherein the distal end of the rotary tool has a probe protruding in a central portion and a shoulder in a peripheral portion, and the probe and the shoulder are constituted by different materials in at least surface portions that are in contact with the metal materials.

In this case, it is preferred that wear resistance of the probe be higher than wear resistance of the shoulder because service life of the rotary tool can be increased.

Further, adherability of the probe to the metal materials is higher than adherability of the shoulder to the metal materials.

With such a configuration, since adherability of the probe to the metal material is higher than adherability of the shoulder to the metal material, stirring of the metal materials is enhanced and volume of the stirring portion is increased. Since adherability of the shoulder to the metal material is lower than adherability of the probe to the metal material, roughening of the processing portion by the shoulder that passes over a wide region of the processing portion can be prevented.

Further, it is preferred that the probe be constituted by at least one of Ir, Mo, W, V, Rh, Ru, Re, Nb, Ta, Zr, and Hf, or an alloy including 50 wt. % or more of at least one of Ir, Mo, W, V, Rh, Ru, Re, Nb, Ta, Zr, and Hf because high wear resistance and adherability of the metal material are maintained.

Alternatively, it is preferred that the probe include at least one of Cr, Si, Mo, V, Al, Nb, Ti, and W because the occurrence of a phase that causes the decrease in corrosion resistance in the processed portion can be inhibited.

Further, it is preferred that the shoulder be constituted by either Si₃N₄ or polycrystalline cubic boron nitride because adherability of the probe to the metal material is higher than adherability of the shoulder to the metal material, stirring of the metal materials is enhanced and volume of the stirring portion can be increased. Further, since adherability of the shoulder to the metal material is lower than adherability of the probe to the metal material, roughening of the processing portion by the shoulder that passes over a wide region of the processing portion can be prevented.

In addition, it is preferred that the probe and the shoulder could be rotated at different rotation speeds because good processed portion is obtained.

Further, it is preferred that the length of protrusion of the probe from the distal end of the rotary tool could be changed because the rotary tool can be used continuously.

Further, it is preferred that the surface portion of the shoulder be covered with a substance having adherability to the metal material lower than adherability of the probe because the effect demonstrated in this case is identical to that obtained when the material of the entire shoulder is changed from that of the probe.

Further, it is preferred that the surface portion of the shoulder is covered with one of Si₃N₄, BN, Al₂O₃, ZrO₂, SiC, B₄C, NiO, SiAlON, MN, TiAlN, TiN, CrN, TiCN, TiSiN, DLC, TiCrN, TiAlSiN, and AlCrSiN because the effect demonstrated in this case is identical to that obtained when the material of the entire shoulder is Si₃N₄ or polycrystalline cubic boron nitride.

Further, it is preferred that the surface portion of the probe be covered with a substance having adherability to the metal material higher than adherability of the shoulder because the effect demonstrated in this case is identical to that obtained when the material of the entire probe is changed from that of the shoulder.

In addition, it is preferred that the surface portion of the probe be covered with a substance having wear resistance with respect to the metal material higher than wear resistance of the shoulder because the effect demonstrated in this case is identical to that obtained when the material of the entire probe is changed from that of the shoulder.

### Advantageous Effects of the Invention

With the metal material processing method and rotary tool in accordance with the present invention, service life of the rotary tool can be increased and a better processing portion can be obtained even when friction stir welding is performed with respect to various sorts of material. Further, the structure processed by the metal material processing method in accordance with the present invention has a good processing portion and excels in mechanical properties.

### BRIEF DESCRIPTION OF THE DRAWINGS

FIG. 1 is a perspective view illustrating the concept of the method for welding metal materials according to the first embodiment.

FIG. 2 is a perspective view illustrating another mode of the method for welding metal materials according to the first embodiment.

FIG. 3 is a cross-sectional view illustrating the structure of the rotary tool according to the first embodiment.

FIG. 4 is a perspective view illustrating the structure of the rotary tool according to the second embodiment.

FIG. 5 is a cross-sectional view illustrating the structure of the rotary tool according to the third embodiment.

FIG. 6 is a graph illustrating the variation of wear mass against the number of welding cycles of the rotary tool in a test example.

FIG. 7 is a cross-sectional view of the welding portion obtained with the rotary tool in accordance with the present invention.

FIG. 8 shows the welding portion, which is obtained with the rotary tool in accordance with the present invention, after a salt water spraying test.

FIG. 9 is a cross-sectional view of the welding portion obtained with the conventional rotary tool constituted only by Si₃N₄.

FIG. 10 shows the welding portion, which is obtained with the conventional rotary tool constituted only by an Ir alloy, before a salt water spraying test.

FIG. 11 shows the welding portion, which is obtained with the conventional rotary tool constituted only by an Ir alloy, after a salt water spraying test.

### DESCRIPTION OF EMBODIMENTS

An embodiment of the present invention will be described below with reference to the appended drawings.

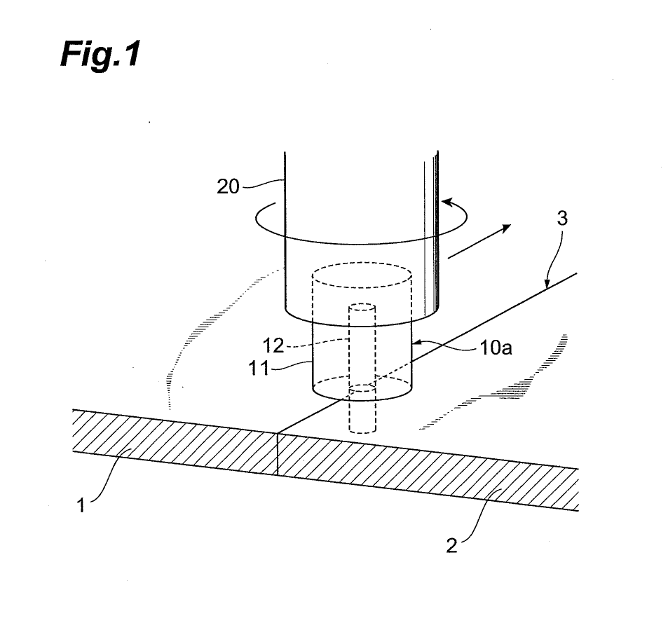

FIG. 1 is a perspective view illustrating the concept of the method for welding metal materials according to the first embodiment. In the present embodiment, as shown in FIG. 1, end portions of plate-like metal materials 1, 2 are abutted against each other in a welding portion 3, a shoulder 11 of the circumferential portion at the distal end of a rotary tool 10a is brought into contact with the welding portion 3, while the rotary tool 10a clamped in a chuck 20 is being rotated, a probe 12 located in the central portion of the distal end of the rotary tool 10a is inserted into the welding portion 3, and the metal materials 1, 2 are welded together. A shield gas constituted by inactive gas such as Ar is supplied to the welding portion 3.

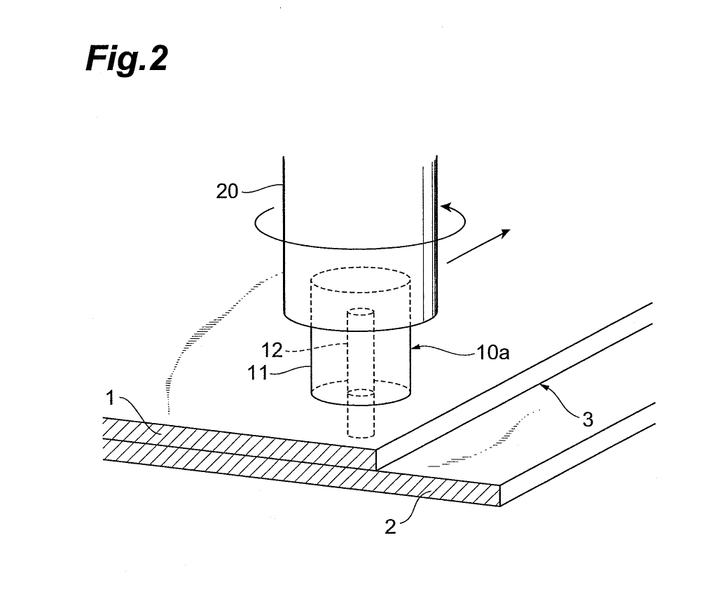

FIG. 2 is a perspective view illustrating another mode of the method for welding metal materials according to the first embodiment. As shown in FIG. 2, in this mode, metal materials 1, 2 are laid one on top of another in the welding portion 3, the rotary tool 10a is inserted, while being rotated, through one metal material 1, into the welding portion 3 and the metal materials 1, 2 are welded together. Similarly to the process illustrated by FIG. 1, a shield gas constituted by inactive gas such as Ar is supplied to the welding portion 3.

In the present embodiment, light alloy materials including Al or the like can be used as the metal materials 1, 2 that are to be welded, but in the present embodiment, because wear of the rotary tool 10a and roughness of the welding portion 3 can be reduced, for example, carbon steels, alloy steels (ISO compliant), austenitic stainless steels such as SUS304, SUS301L, and SUS316L, and ferritic stainless steels such as SUS430 or two-phase stainless steels can be used for the metal materials 1, 2. Alternatively, dissimilar materials, rather than identical materials, can be also used as the metal materials 1, 2. More specifically, for example, welding of carbon steels such as welding of SS400 and S45C, welding of carbon steel and stainless steel, such as welding of SS400 and SUS304, welding of light alloys such as welding of A5083 and AZ41, welding of aluminum alloys that are non-heat-treated materials such as A5083 with a large plate thickness, and welding of a non-heat-treated material and a heat-treated material, such as welding of A5083 and A6N01, can be performed by the welding method of the present embodiment. Alternatively, at least any one of Ni-base alloys, Ti, Co, Rh, Pd, Cu, Pt, and Au, or alloys including at least one of stainless steels, carbon steels, alloyed steels, Ni-base alloys, Ti, Co, Rh, Pd, Cu, Pt, and Au can be used as the metal materials 1, 2 that are to be welded.

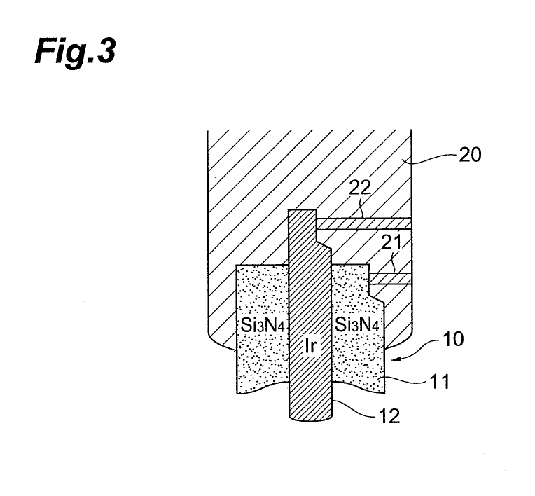

FIG. 3 is a cross-sectional view illustrating the structure of the rotary tool according to the first embodiment. FIG. 3 and the aforementioned FIGS. 1 and 2 illustrate the substantially cylindrical rotary tool 10a that has the probe 12 protruding in a central portion of the distal end and the shoulder 11 in the peripheral portion. As shown in FIG. 1, in the structure of the present embodiment, the shoulder 11 and the probe 12 are separate components constituted by different materials.

The shoulder 11 has a cylindrical shape with a through hole in the central portion thereof. The probe 12 has a round columnar shape with a diameter less than that of the shoulder 11 and protrudes from the distal end of the rotary tool 10a through the through hole in the central portion of the shoulder 11. The shoulder 11 is fixed at the side surface thereof to the chuck 20 with a lock screw 21 provided with a hexagonal hole. The probe 12 is fixed at the side surface thereof to the chuck 20 with a lock screw 22 provided with a hexagonal hole. Since the shoulder 11 and the probe 12 are fixed to the chuck 20 with lock screws 21, 22 provided with hexagonal holes, the shoulder and the probe rotate at the same rotation speed in the same rotation direction, following the rotation of the chuck 20 during welding.

In the example shown in FIG. 3, the shoulder 11 and the probe 12 are fixed only in one location at the side surface, but the shoulder 11 and the probe 12 can be fixed more reliably to the chuck 20 by fixing the shoulder 11 and the probe 12 in three locations spaced by 120° with respect to the rotation axis of the rotary tool 10a.

Further, the probe 12 may be provided slidably along the through hole of the shoulder 11 and the probe 12 may be fixed at a different length of protrusion from the distal end of the rotary tool 10a. With such a configuration, even when probe 12 is worn out during processing, the rotary tool 10a can be used continuously by changing the protrusion length of the probe 12 from the distal end of the rotary tool 10a.

The probe 12 is constituted by an Ir alloy that excels in wear resistance and adherability to the metal materials 1, 2. The material of the probe 12 can be at least one of Ir, Mo, W, V, Rh, Ru, Re, Nb, Ta, Zr, and Hf, or an alloy including 50 wt. % or more of at least one of Ir, Mo, W, V, Rh, Ru, Re, Nb, Ta, Zr, and Hf. Alternatively, the probe 12 can include at least any one of Cr, Si, Mo, V, Al, Nb, Ti, and W. Where the probe 12 includes at least any one of Cr, Si, Mo, V, Al, Nb, Ti, and W, which are ferrite stabilizing elements, the occurrence of σ phase that causes the decrease in corrosion resistance in the welding portion 3 can be inhibited. Subjecting the material used for the probe 12 to forging is more effective in terms of extending the tool life.

The shoulder 11 is from Si₃N₄ that makes it possible to reduce wear resistance and adherability to the metal materials 1, 2 to levels below those of the probe 12. Either of Si₃N₄ and polycrystalline cubic boron nitride (PCBN) can be used as the material of the shoulder 11, and other ceramic material can be also used. In the present embodiment, the probe 12 and the shoulder 11 are from different materials and the rotary tool 10a has a structure in which the two are fitted together. Stress concentration can be relaxed and durability can be further increased by using the probe 12 with an oval cross section.

In the probe 12, only the surface portion thereof can be covered with at least one of Ir, Mo, W, V, Rh, Ru, Re, Nb, Ta, Zr, and Hf, or an alloy including 50 wt. % or more of at least one of Ir, Mo, W, V, Rh, Ru, Re, Nb, Ta, Zr, and Hf, and the effect can be demonstrated that is identical to that obtained when the entire substance is from the abovementioned substance. Further, in the shoulder 11, only the surface portion thereof can be covered with any of Si₃N₄, BN, Al₂O₃, ZrO₂, SiC, B₄C, NiO, SiAlON, MN, TiAlN, TiN, CrN, TiCN, TiSiN, DLC, TiCrN, TiAlSiN, and AlCrSiN, and the effect can be demonstrated that is identical to that obtained when the entire substance is from the abovementioned substance.

For example, the entire probe 12 can be from an Ir alloy, and the shoulder 11 can be covered with Si₃N₄.

Alternatively, the entire rotary tool 10a can be from an Ir alloy, and the surface of either of the shoulder 11 and the probe 12 can be covered with any of Si₃N₄, BN, Al₂O₃, ZrO₂, SiC, B₄C, NiO, SiAlON, AlN, TiAlN, TiN, CrN, TiCN, TiSiN, DLC, TiCrN, TiAlSiN, and AlCrSiN. In this case, the wear level of the probe 12 is generally higher than that of the shoulder 11. Therefore, the coating on the surface of the probe 12 is rapidly removed due to wear during processing, the Ir alloy of the probe 12 is exposed, and the effect obtained is similar to that obtained in the case in which the entire shoulder 11 and the entire probe 12 are from different substances.

Since adherability is good, the protrusion length of the probe 12 can be set less than the usual probe length. For example, the protrusion length is equal to or less than 1.5 mm, which is shorter than usual, more preferably equal to or less than 1.35 mm. Further, the probe length is usually set to about 1.4 mm when the metal materials 1, 2 have a sheet thickness of 1.5 mm, but welding is also possible with the probe length of 1.3 mm. This is because the Ir alloy of the probe 12 has high adherability to the metal materials 1, 2 and stirring is enhanced. Further, reducing the protrusion length of the probe 12 as mentioned hereinabove makes it possible to perform welding without fracturing the rotary tool 10a even when the sheet thickness of the metal materials 1, 2 changes. In addition, in this case, the tool service life can be extended.

The operation of the welding method and rotary tool of the present embodiment will be explained below. The inventors have performed a friction stir welding test by changing the material of the conventional rotary tool with respect to various metal materials and the following information was obtained. First, where welding is performed by using a rotary tool composed of Si₃N₄, the rotary tool demonstrates significant wear when the metal materials to be welded are as hard as stainless steel or carbon steel. Further, when the welding speed increases, the service life of the rotary tool tends to shorten. In addition, when materials with a high melting point, such as austenitic stainless steels, are welded with the conventional rotary tool constituted by Si₃N₄ or polycrystalline cubic boron nitride, corrosion resistance of the welding stirred portion tends to decrease.

Where austenitic stainless steels are welded by the conventional rotary tool made from an Ir alloy, the adherability (affinity) of the Ir alloy and stainless steel is high, the welding portion surface is roughened after the shoulder of the rotary tool has passed over the welding portion surface, and corrosion resistance tends to decrease.

Accordingly, in the present embodiment, the shoulder 11 and the probe 12 of the rotary tool 10a are made from different materials. The probe 12 is from a substance with high wear resistance and high adherability to the metal materials 1, 2 which are the materials to be welded. Meanwhile, the shoulder 11 is from a substance with low wear resistance and low adherability to the metal materials 1, 2. Where thermal conductivity coefficients of the probe 12 and the shoulder 11 are lower than those of the metal materials 1, 2, the effect of heat input that is used for welding is improved.

Accordingly, the probe 12 is taken to include Ir, Mo, W, V, Rh, Ru, Re, Nb, Ta, Zr, and Hf, or an alloy including 50 wt. % or more of at least one of Ir, Mo, W, V, Rh, Ru, Re, Nb, Ta, Zr, and Hf, and the shoulder 11 is taken to include Si₃N₄ and polycrystalline cubic boron nitride. As a result, the probe 12 has high wear resistance and high adherability to metal materials 1, 2 and the like. Therefore, even when hard metal materials 1, 2 are welded, the service life of the rotary tool 10a can be increased, corrosion resistance of the welding stirred portion can be increased, and stirring of the welding portion 3 can be enhanced. Further, since the shoulder 11 has high wear resistance and low adherability to metal materials 1, 2, and the like, roughening of the surface of the welding portion 3 after the shoulder 11 has passed therethrough can be prevented and corrosion resistance of the welding portion 3 can be increased even when stainless steel is welded. Therefore, in accordance with the present embodiment, the structure obtained by welding metal materials 1, 2 has a good processing portion and excels in mechanical properties.

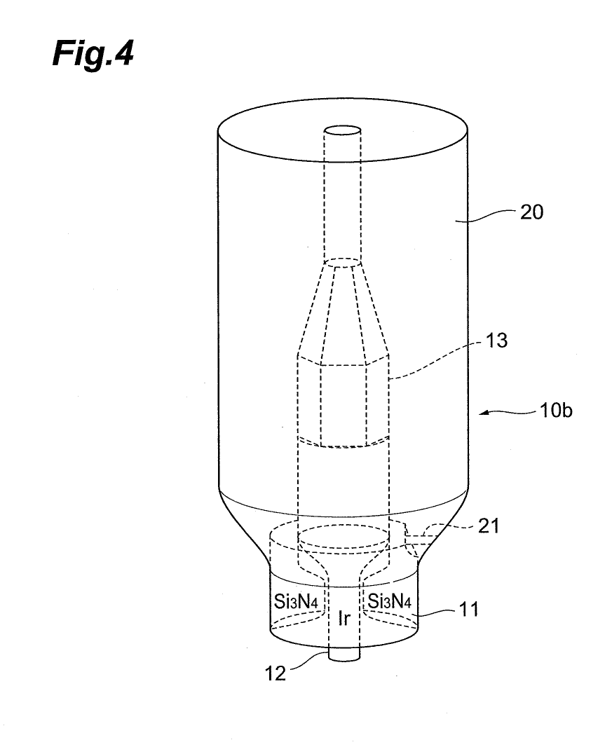

FIG. 4 is a perspective view illustrating the structure of the rotary tool according to the second embodiment. As shown in FIG. 4, the probe 12 of a rotary tool 10b of the present embodiment has a columnar shape with a hexagonal columnar surface 13 in part of the side surface thereof. The chuck 20 is provided with a holding hole having the inner wall surface such that corresponds to the hexagonal columnar surface 13. The probe 12 is fixed to the chuck 20 by mating the hexagonal columnar surface 13 with the inner wall surface of the holding hole of the chuck 20. After the probe 12 is passed through the through hole formed in the central portion of the shoulder 11, the shoulder 11 is fixed to the chuck 20 with the lock screw 21 provided with a hexagonal hole, in the same manner as in the abovementioned first embodiment.

The thermal expansion coefficient of the chuck 20 is less than the thermal expansion coefficient of the probe 12. As a result, the probe 12 expands under the effect of heat generated during welding to a degree higher than that of the chuck 20, and the probe 12 is strongly fixed by the chuck 20. After completion of welding, the probe 12 shrinks due to radiation cooling to a degree higher than that of the chuck 20, and the probe 12 can be easily taken off the chuck 20.

According to the present embodiment, the lock screw 21 provided with a hexagonal hole is used only for the shoulder 11 when the rotary tool 10b is fixed to the chuck 20. The resultant merit is that the rotary tool 10b can be easily attached to the chuck 20 and detached therefrom.

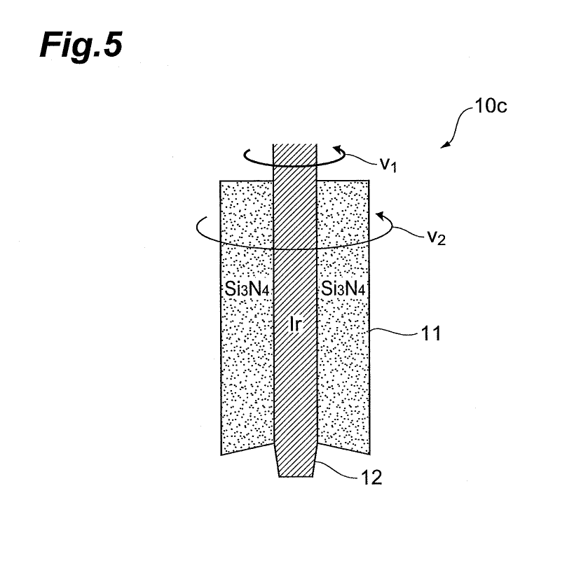

FIG. 5 is a cross-sectional view illustrating the structure of the rotary tool according to the third embodiment. As shown in FIG. 5, a rotary tool 10c according to the present embodiment is similar to the rotary tool of the abovementioned first embodiment in that the probe 12 is made from Ir or the like and the shoulder 11 is made from Si₃N₄ or the like, but the present embodiment differs from the first embodiment in that the probe 12 and the shoulder 11 can be rotated at different rotation speeds v₁, v₂ and that the rotation speed v₁ of the probe is higher than the rotation speed v₂ of the shoulder. In this case, the shoulder 11 and the probe 12 are taken to be rotated in the same direction. In the example shown in FIG. 5, the probe 12 and the shoulder 11 can be rotated at respective different rotation speeds v₁, v₂ in the same direction, but the rotation may be also performed at respective different rotation speeds v₁, v₂ in opposite directions.

In accordance with the present embodiment, since the probe 12 and the shoulder 11 can be rotated at different rotation speeds and that the rotation speed v₁ of the probe 12 is higher than the rotation speed v₂ of the shoulder 11, the temperature of the center of the welding portion 3 where a high temperature is desirable can be raised by rotating the probe 12 at a high speed, and the temperature of the entire processing portion 3, which is preferred, as a whole, to be maintained at a low temperature, can be reduced by rotating the shoulder 11 at a low speed.

The metal material processing method, structure processed by the metal material processing method, and rotary tool in accordance with the present invention are not limited to above-described embodiments, and it goes without saying that various changes can be made without departing for the scope and essence of the present invention.

Described below are test results obtained by the inventors in actual welding of metal materials by the metal material processing method in accordance with the present invention.

### Example 1

A test sample was produced by friction stir welding the plate materials constituted by SUS304 and having a thickness of 1.5 mm, a length of 165 mm, and a width of 35 mm by the method illustrated by FIG. 1. The rotary tool 10a such as shown in FIG. 3 was used, the material of the probe 12 was an Ir alloy, and the material of the shoulder 11 was Si₃N₄. The diameter of the shoulder 11 was 15.0 mm, the R dimension of the end portion of the shoulder 11 was 1.0 mm, the diameter of the probe 12 was 6.0 mm, and the protrusion length of the probe 12 was 1.35 mm, which is less than usual. This is because the Ir alloy of the probe 12 has good adherability to SUS304 and stirring can be enhanced. By setting a small protrusion length of the probe 12 as mentioned hereinabove, it is possible to perform welding, without breaking the rotary tool 10a, even when the thickness of the plate materials that are the materials to be processed changes. The welding was conducted under the following conditions: the rotation speed of the rotary tool 10a was 600 rpm, the inclination angle was 3°, the welding load on SUS304 was 1360 kg, the welding speed was 300 mm/min or 600 mm/min, and Ar gas was supplied as a shield gas at a flow rate of 30 L/min. For comparison, a test sample was produced by conducting friction stir welding in a similar manner with the conventional rotary tool constituted only by Si₃N₄ and a rotary tool constituted only by an Ir alloy.

The cross section of the produced samples was observed under an electron microscope. A salt water spraying test was performed by spraying 10 wt. % salt water on the welding portions of the samples and allowing the samples to stay for several hundreds of hours in an environment with a temperature of 35° C. and a humidity of 95%.

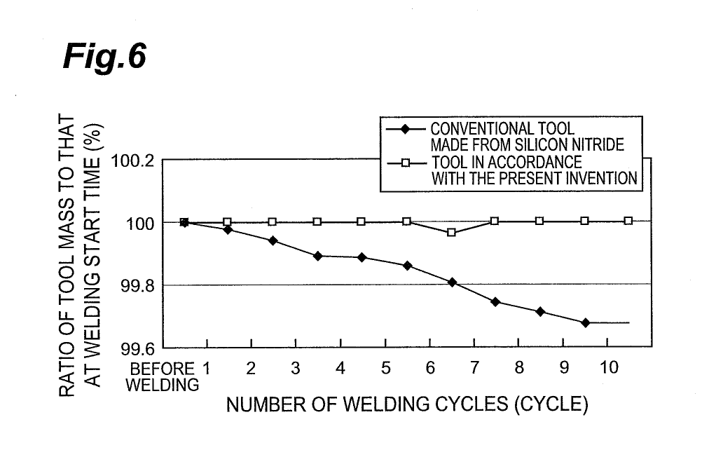

FIG. 6 is a graph illustrating the variation of wear mass against the number of welding cycles of the rotary tool in the test example. As shown in FIG. 6, it is clear that the rotary tool 10a in accordance with the present invention shows no wear even after 10 cycles of welding, whereas the conventional rotary tool constituted only by Si₃N₄ demonstrates significant wear.

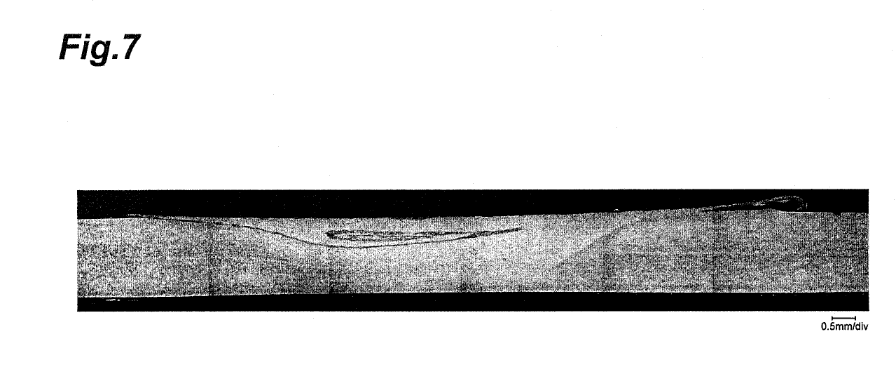

FIG. 7 is a cross-sectional view of the welding portion obtained with the rotary tool in accordance with the present invention. As shown in FIG. 7, it is clear that a band-like layer serving as an easily corrodible layer is not seen in the welding portion obtained with the rotary tool 10a in accordance with the present invention and no roughening is observed in the welding portion 3. The welding speed in this case is 300 mm/min.

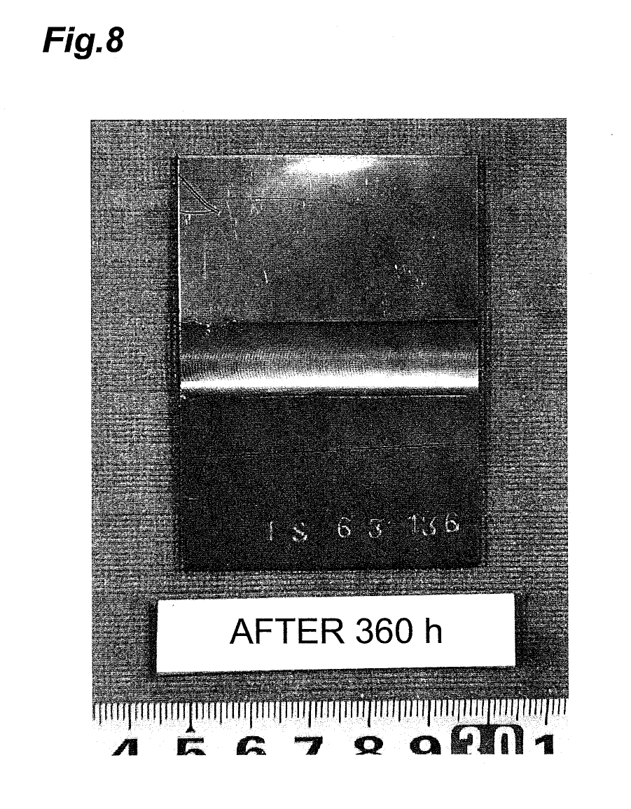

FIG. 8 shows the welding portion, which is obtained with the rotary tool in accordance with the present invention, after a salt water spraying test. As shown in FIG. 8, it is clear that no corrosion has occurred in the welding portion even after 360 h have elapsed after spraying the welding portion with salt water.

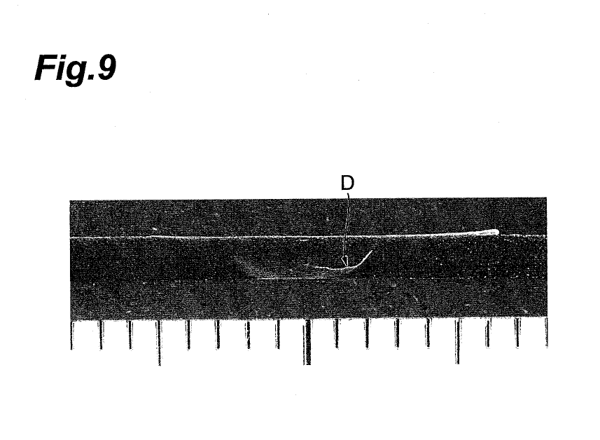

FIG. 9 is a cross-sectional view of the welding portion obtained with the conventional rotary tool constituted only by Si₃N₄. As shown in FIG. 9, a band-like layer D serving as an easily corrodible layer is observed in the welding portion obtained with the conventional rotary tool constituted only by Si₃N₄. The welding speed in this case is 600 mm/min.

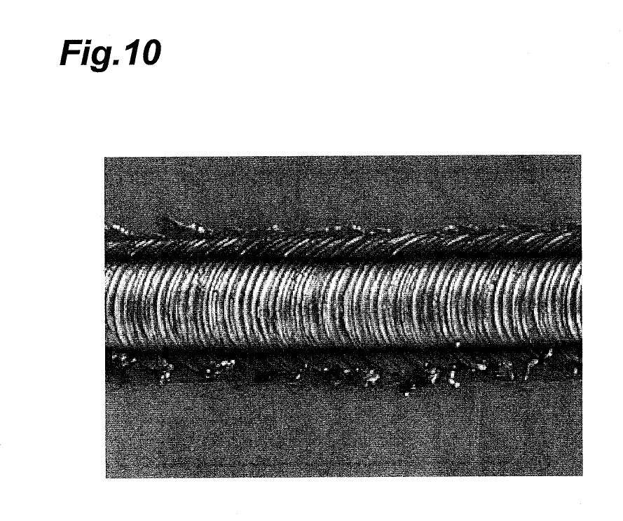

FIG. 10 shows the welding portion, which is obtained with the conventional rotary tool constituted only by an Ir alloy, before a salt water spraying test. As shown in FIG. 10, it is clear that the number of asperity in the welding portion is large and roughness has occurred therein even before the welding portion 3 has been sprayed with salt water.

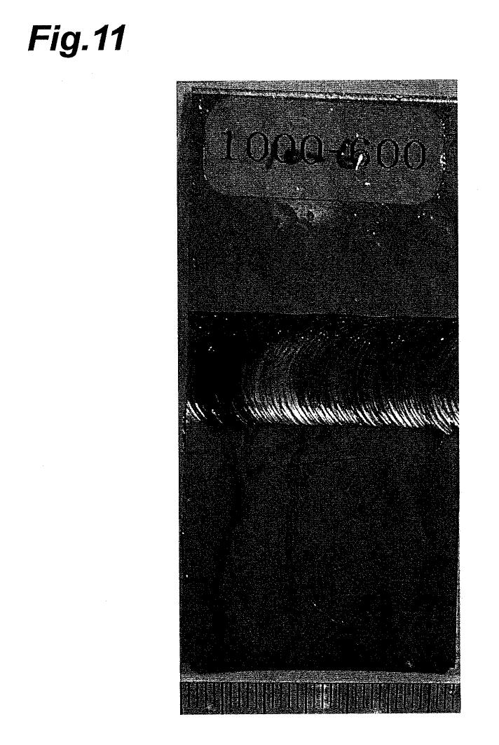

FIG. 11 shows the welding portion, which is obtained with the conventional rotary tool constituted only by an Ir alloy, after a salt water spraying test. As shown in FIG. 11, it is clear that a large amount of corrosion has appeared in the welding portion after 100 h have elapsed after spraying the welding portion with salt water.

Further, metal materials with a sheet thickness of 1.5 mm were also butt welded by the welding method according to the present test example by using the rotary tool 10a with the probe 12 from an Ir alloy with a protrusion length of 1.35 mm and the shoulder 11 from silicon nitride with a shoulder diameter of 15 mm. The suitable welding condition range is shown in Table 1 below. The suitable welding condition range as referred to herein represents the conditions under which the strength determined in the tensile test of the joint is equal to that of the base material.

TABLE 1

| Welding speed | Welding load | Welding rotation |
|---|---|---|
| (mm/min) | (ton) | speed (rpm) |
| 600 | 2.60 | 600 |
| | 2.00 | 900 |
| 800 | 3.80 | 600 |
| | 2.70 | 900 |
| 1000 | 4.20 | 600 |
| | 3.25 | 900 |

### INDUSTRIAL APPLICABILITY

With the metal material processing method and rotary tool in accordance with the present invention, service life of the rotary tool can be increased and a better processing portion can be obtained even when friction stir welding is performed with respect to various sorts of materials. Further, the structure processed by the metal material processing method in accordance with the present invention has a good processing portion and excels in mechanical properties.

### REFERENCE SIGNS LIST

1, 2 base material
3 welding portion
10a, 10b, 10c rotary tools
11 shoulder
12 probe
13 hexagonal columnar surface
20 chuck
21 lock screw provided with a hexagonal hole
22 lock screw provided with a hexagonal hole

1. A metal material processing method in which by arranging two metal materials to face each other in a processing portion and inserting a distal end of a rod-shaped rotary tool into the processing portion while rotating the rotary tool, the two metal materials are processed,
wherein the distal end of the rotary tool has a probe protruding in a central portion and a shoulder in a peripheral portion, and the probe and the shoulder are constituted by different materials in at least surface portions that are in contact with the metal materials.

2. The metal material processing method according to claim 1,
wherein wear resistance of the probe is higher than wear resistance of the shoulder.

3. The metal material processing method according to claim 1,
wherein adherability of the probe to the metal materials is higher than adherability of the shoulder to the metal materials.

4. The metal material processing method according to claim 1,
wherein the probe is constituted by at least one of Ir, Mo, W, V, Rh, Ru, Re, Nb, Ta, Zr, and Hf, or an alloy including 50 wt. % or more of at least one of Ir, Mo, W, V, Rh, Ru, Re, Nb, Ta, Zr, and Hf.

5. The metal material processing method according to claim 1,
wherein the probe includes at least one of Cr, Si, Mo, V, Al, Nb, Ti, and W.

6. The metal material processing method according to claim 1,
wherein the shoulder is constituted by either Si₃N₄ or polycrystalline cubic boron nitride.

7. The metal material processing method according to claim 1,
wherein the probe and the shoulder can be rotated at different rotation speeds, and the rotation speed of the probe is higher than the rotation speed of the shoulder.

8. The metal material processing method according to claim 1,
wherein a length of protrusion of the probe from the distal end of the rotary tool can be changed.

9. The metal material processing method according to claim 1,
wherein the surface portion of the shoulder is covered with a substance having adherability to the metal material lower than adherability of the probe.

10. The metal material processing method according to claim 9,
wherein the surface portion of the shoulder is covered with one of Si₃N₄, BN, Al₂O₃, ZrO₂, SiC, B₄C, NiO, SiAlON, AlN, TiAlN, TiN, CrN, TiCN, TiSiN, DLC, TiCrN, TiAlSiN, and AlCrSiN.

11. The metal material processing method according to claim 1,
wherein the surface portion of the probe is covered with a substance having adherability to the metal material higher than adherability of the shoulder.

12. The metal material processing method according to claim 1,
wherein the surface portion of the probe is covered with a substance having wear resistance with respect to the metal material higher than wear resistance of the shoulder.

13. The metal material processing method according to claim 1,
wherein the metal material is constituted by at least one of stainless steels, carbon steels, alloy steels, Ni-base alloys, Ti, Co, Rh, Pd, Cu, Pt, and Au, or alloys including at least one of stainless steels, carbon steels, alloyed steels, Ni-base alloys, Ti, Co, Rh, Pd, Cu, Pt, and Au.

14. A structure processed by the metal material processing method according to claim 1.

15. A rotary tool for use in a metal material processing method in which by arranging two metal materials to face each other in a processing portion and inserting a distal end of a rod-shaped rotary tool into the processing portion while rotating the rotary tool, the two metal materials are processed,
wherein the distal end of the rotary tool has a probe protruding in a central portion and a shoulder in a peripheral portion, and
wherein the probe and the shoulder are constituted by different materials in at least surface portions that are in contact with the metal materials.

16. The rotary tool according to claim 15,
wherein wear resistance of the probe is higher than wear resistance of the shoulder.

17. The rotary tool according to claim 15,
wherein adherability of the probe to the metal materials is higher than adherability of the shoulder to the metal materials.

18. The rotary tool according to claim 15,
wherein the probe is constituted by at least one of Ir, Mo, W, V, Rh, Ru, Re, Nb, Ta, Zr, and Hf, or an alloy including 50 wt. % or more of at least any of Ir, Mo, W, V, Rh, Ru, Re, Nb, Ta, Zr, and Hf.

19. The rotary tool according to claim 15,
wherein the probe includes at least one of Cr, Si, Mo, V, Al, Nb, Ti, and W.

20. The rotary tool according to claim 15,
wherein the shoulder is constituted by either Si₃N₄ or polycrystalline cubic boron nitride.

21. The rotary tool according to claim 15,
wherein the probe and the shoulder can be rotated at different rotation speeds.

22. The rotary tool according to claim 15,
wherein a length of protrusion of the probe from the distal end of the rotary tool can be changed.

23. The rotary tool according to claim 15,
wherein the surface portion of the shoulder is covered with a substance having adherability to the metal material lower than adherability of the probe.

24. The rotary tool according to claim 23,
wherein the surface portion of the shoulder is covered with one of Si₃N₄, BN, Al₂O₃, ZrO₂, SiC, B₄C, NiO, SiAlON, AlN, TiAlN, TiN, CrN, TiCN, TiSiN, DLC, TiCrN, TiAlSiN, and AlCrSiN.

25. The rotary tool according to claim 15,
wherein the surface portion of the probe is covered with a substance having adherability to the metal material higher than adherability of the shoulder.

26. The rotary tool according to claim 15,
wherein a surface portion of the probe is covered with a substance having wear resistance with respect to the metal material higher than wear resistance of the shoulder.
